(19) United States
(12) Patent Application Publication
(10) Pub. No.: US 2006/0218338 A1
(43) Pub. Date: Sep. 28, 2006

(54) Method for preventing software from being wrongly burned

(75) Inventor: Jeffrey Lo, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/089,280

(22) Filed: Mar. 23, 2005

(51) Int. Cl. G06F 12/00

(52) U.S. Cl. 711/103

(57) ABSTRACT

A method for preventing software from being wrongly burned is proposed, such that the software can be correctly burned into a storage unit of a device utilizing and corresponding to the software, so as to provide normal operation of the software. First, both of the software and the storage unit are provided with a recognition code corresponding to the foregoing device. Then, it is determined whether the recognition code of the software is consistent with that of the storage unit before performing a burning process. If the codes are consistent, then the software is burned into the storage unit, whereas if the codes are inconsistent, then the burning process is not performed. Accordingly, in the present invention, the recognition code corresponding to the device is simultaneously provided to the software and the storage unit and the recognition codes are compared before performing the burning process. The burning process is performed only if the recognition codes are consistent. Therefore, the present invention is capable of providing normal operation of the device utilizing the software and providing the user an advantage as the burning process can be easily performed.

### FIELD OF THE INVENTION

The present invention relates to a method for preventing software from being wrongly burned, and more particularly, to a method for preventing software from being wrongly burned that is applicable to basic input/output system (BIOS) software.

### BACKGROUND OF THE INVENTION

Referring to architecture of a present-day computer, a so-called basic input output system (BIOS) is the most basic software required for basic operation of the computer. Additionally, it is also the initial software which is processed once the computer is switched on. BIOS software, which mainly comprises a low-level instruction set of a computer, provides the computer with the most basic hardware testing during the power-on phase, defines characteristics of the computer, and processes basic jobs. For example, when the computer is switched on, a power-on self-test (POST) is performed, signals sent out by a keyboard are interpreted, and transmission of information between connection ports occurs. Therefore, the initial operation of the computer after the computer has been switched on is performed according to the contents of the BIOS software. If an error has occurred in the BIOS software during or subsequent to the burning phase, tests of the random access memory (RAM), hard drive (HD), and the central processing unit (CPU) cannot be performed properly when the computer is switched on, such that the computer cannot be successfully or reliably switched on for operation. As the BIOS software is critical in a computer system, the BIOS software instruction set is generally “burned” in a non-volatile memory device such as a flash ROM, PROM, EPROM or EEPROM which can maintain the contents of programs or data over a long period of time without any power. Such a memory device is typically provided on a mother board of the computer where it is accessible to the microprocessor once the motherboard is powered on.

Along with the improvements in processing efficiency and the peripheral hardware devices of a computer system, different versions of BIOS software are constantly proposed by computer manufacturers to keep pace with such improvements and to differentiate their products. Thus, computer systems are able to reliably determine the presence of and configure peripheral hardware devices, such that operation between the peripheral hardware devices and the computer system can be successfully performed. Thereafter, normal operation can be performed on the computer system by a computer system user or a BIOS software tester before release to market. However, as previously mentioned, the BIOS software needs to be burned into the memory of the computer system corresponding to the BIOS software. Therefore, in order to achieve normal operation of the BIOS software in the computer system, the BIOS software has to match the mother board employing the BIOS, so as to perform successful operation of the computer system both during power-on and in subsequent operation.

Referring to the prior-art shown in FIG. 1, a burning program is executed (Step S10) and software (such as BIOS software) is burned into a memory device (Step S11). Then, the burning program terminates (Step S12) prior to installation of the BIOS software memory device on a motherboard using an insertion method, such that subsequent functional tests can be performed. In general, during the burning process of the BIOS software, an operator has to determine the correct version of BIOS software needed for the particular motherboard being equipped with BIOS software. However, if the BIOS software of an incorrect version is burned into the memory device by the operator, as sometimes happens, then the motherboard utilizing the memory device cannot operate normally during or subsequent to the boot-up process, and, in some cases, the computer system will not even boot-up. Thus, it's essential that BIOS software of a correct version be burned and installed into a corresponding motherboard of the computer system employing the BIOS. Therefore, referring to the prior-art burning method, not only can abnormal operation of the computer system result, but also unreliability and inconvenience in the manufacturing process exist.

Accordingly, the problem to be solved here is to provide the operator a burning method by which BIOS software with a correct version can be burned in the memory device, so as to achieve normal operation for the computer system and to avoid errors and wasted time during the manufacturing process.

### SUMMARY OF THE INVENTION

In light of the above prior-art drawbacks, a primary objective of the present invention is to provide a method for preventing software from being wrongly burned, such that the software can be easily and correctly burned by an operator during manufacture or subsequent system reconfiguration.

Another objective of the present invention is to provide a method for preventing software from being wrongly burned, such that abnormal operation of the device utilizing the software due to a BIOS mismatch can be avoided.

In accordance with the above and other objectives, the present invention proposes a method for preventing software from being wrongly burned, comprising steps of:

providing each of the software and a storage unit with a recognition code corresponding to the device that will utilize the storage unit and software; and

determining whether the recognition code of the software is consistent with that of the storage unit before performing a burning process, whereupon, if the codes are consistent, the software is burned into the storage unit, whereas, if the codes are inconsistent, the burning process is not performed.

Accordingly, in the present invention, the recognition code corresponding to the device is simultaneously provided to the software and the storage unit, and the recognition codes are compared before performing the burning process. That is, the burning process is performed only if the recognition codes are consistent. Therefore, in comparison to the prior-art burning method, the present invention is capable of providing normal operation of the device corresponding to the software and providing the operator an advantage as the burning process can be easily and correctly performed.

### BRIEF DESCRIPTION OF THE DRAWINGS

The present invention can be more fully understood by reading the following detailed description of the preferred embodiments, with reference made to the accompanying drawings, wherein:

FIG. 1 is a flowchart showing the steps of a software burning method according to the prior-art;

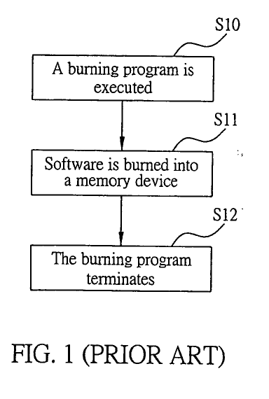

FIG. 2 is a flowchart showing steps of a method for preventing software from being wrongly burned according to the present invention; and

FIG. 3(A) and FIG. 3(B) are block diagrams showing the relationships of the components in the method for preventing software from being wrongly burned proposed in the present invention.

### DETAILED DESCRIPTION OF THE EMBODIMENTS

The present invention is described in the following with specific embodiments, so that one skilled in the pertinent art can easily understand other advantages and effects of the present invention from the disclosure of the invention. The present invention may also be implemented and applied according to other embodiments, and the details may be modified based on different views and applications without departing from the spirit of the invention.

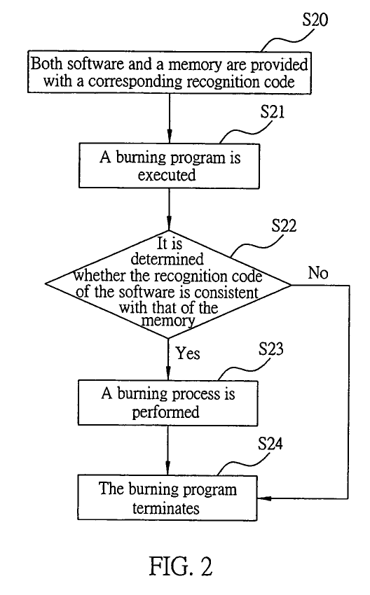

FIG. 2 is a flowchart showing the steps of a method for preventing software from being wrongly burned according to the present invention. The flowchart is used to provide detailed description of a preferred embodiment of a method for preventing software from being wrongly burned proposed in the present invention. It should be noted that the drawings are simplified and only the basic construction of the present invention is shown. Therefore, only descriptions related to the present invention are utilized in the drawing, and such descriptions are simplified.

Referring to FIG. 2, the flowchart shows a method for preventing software from being wrongly burned as proposed in the present invention, such that the software can be correctly burned into a storage unit of a device or a machine corresponding to the software, so as to provide normal operation of the software. The storage unit is a type of non-volatile memory device selected from the group consisting of a flash ROM, PROM, EPROM and EEPROM, etc.

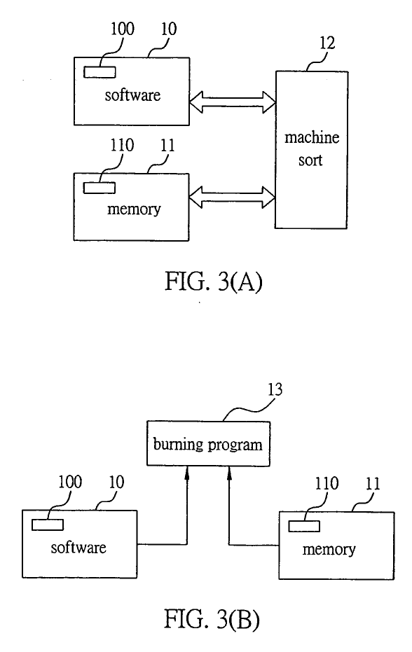

First, Step S20 is performed to establish a recognition code in both the software and the memory device that corresponds with the machine or device that will utilize the memory device and software that will be burned into the memory device. Meanwhile, referring to FIG. 3(A), this step is performed to set recognition codes 100 and 110 corresponding to a device or machine 12 (shown as a machine sort 12 in FIG. 3(A)) in software 10 and memory device 11, respectively. For example, the recognition code 110 is provided in the memory device 11 such as an “AA” machine type (sort) burned into memory device 11 using a burning process. In other words, the recognition code 110 (an “AA” string) is burned at a specific address in the memory device 11, and the recognition code 100 (also an “AA” string) is also provided in the software 10 at a particular software address. The foregoing memory device 11 will subsequently be built-in or externally connected to the device corresponding to the foregoing machine type 12. Moreover, the foregoing software is the basic input output system (BIOS) software that the machine will utilize. The foregoing device is typically a motherboard, and so the machine sort 12 of the diagram could be a motherboard for a system corresponding with the recognition codes. Subsequently, Step S21 is performed.

In Step S21, a burning program is executed. In an alternate view of the process showing the component relationships, FIG. 3(B) depicts the burning program 13 in relationship with the BIOS software 10 and the memory device 11. The burning program 13 is provided on a burning platform having a display, such that a user is able to read relative information using the display. Subsequently, Step S22 is performed.

In Step S22, it is determined whether the recognition code of the BIOS software is consistent with that of the memory device. Specifically, referring to FIG. 3(B), it is determined whether the recognition code 100 of the software 10 is consistent with the recognition code 110 of the memory device 11 using the foregoing burning program 13 of the burning platform (not shown). If the codes are consistent (that is, recognition code 100=recognition code 110), then Step S23 is performed, whereas, if the codes are inconsistent (that is, recognition code 100≠recognition code 110), then Step S24 is performed instead, which effectively terminates the burning process prior to any actual burning of software 10 into the memory device 11.

In Step S23, a burning process is performed. Specifically, referring to FIG. 3(B), the software 10 is burned into the memory device 11 by the burning program 13 of the burning platform (not shown) when the recognition code 100 of the software 10 and the recognition code 110 of the memory 11 are consistent. Then, Step S24 is performed.

In Step S24, the burning program terminates. Referring to FIG. 3(B), the burning program 13 terminates in either the case that the recognition code 100 of the software 10 and the recognition code 110 of the memory device 11 are inconsistent or upon completion of the software 10 being burned into the memory device 11 if it was determined that the recognition codes 100, 110 were consistent. In the case that the recognition code 100 of the software 10 is inconsistent with the recognition code 110 of the memory device 11, an error signal is sent out by the burning program 13 to the burning platform, such that an error indication is displayed on the display of the burning platform. Thus, the user is alerted to the mismatch and is able to replace either the software 10 or the memory device 11, so that the software 10 can be correctly burned in the memory device 11 of a device or machine corresponding to the software 10 by the burning program 13.

Accordingly, in the present invention, the recognition code corresponding to the device is simultaneously provided to the software and the storage unit (memory device), and the recognition codes are compared before performing the burning process. The burning process is performed only if the recognition codes are consistent. Therefore, in comparison to the prior-art burning method, the present invention is capable of providing normal operation of the device corresponding to the software and providing the operator with an advantage as the burning process can be easily and correctly performed.

It should be apparent to those skilled in the art that the above description is only illustrative of specific embodiments and examples of the present invention. The present invention should therefore cover various modifications and variations made to the herein-described structure and operations of the present invention, provided they fall within the scope of the present invention as defined in the following appended claims.

What is claimed is:

1. A method for preventing software from being wrongly burned, such that software can be correctly burned into a storage unit of a device utilizing the software, so as to provide normal operation of the software, the method comprising steps of:
providing both the software and the storage unit with a recognition code corresponding to the device; and
determining whether the recognition code of the software is consistent with that of the storage unit before performing a burning process, whereupon, if the codes are consistent, the software is burned into the storage unit, and, if the codes are inconsistent, the burning process is not performed.

2. The method for preventing software from being wrongly burned of claim 1, wherein the software is basic input output system (BIOS) software.

3. The method for preventing software from being wrongly burned of claim 1 or claim 2, wherein the device is a motherboard.

4. The method for preventing software from being wrongly burned of claim 1, wherein the recognition code is provided in the storage unit by a burning method.

5. The method for preventing software from being wrongly burned of claim 1, wherein the storage unit is built in or externally connected to the device.

6. The method for preventing software from being wrongly burned of claim 1, wherein the software is burned in the storage unit by a burning program.

7. The method for preventing software from being wrongly burned of claim 6, wherein determination of whether the recognition code of the software is consistent with that of the storage unit is made by the burning program.

8. The method for preventing software from being wrongly burned of claim 6 or claim 7, wherein the burning program is provided on a burning platform having a display.

9. The method for preventing software from being wrongly burned of claim 8, wherein, when the recognition code of the basic input output system software is inconsistent with the recognition code of the memory, an error signal is sent out to the burning platform by the burning program, such that an error indication may be displayed on the display of the burning platform.

10. The method for preventing software from being wrongly burned of claim 1, wherein the storage unit is a memory device.

11. The method for preventing software from being wrongly burned of claim 1, 4, 5, 6, 7, or 10, wherein the storage unit is selected from the group consisting of a flash ROM, PROM, EPROM, and EEPROM.

12. A method for preventing software from being wrongly burned, such that software can be correctly burned by a burning program into a storage device of a machine corresponding to the software, so as to provide for normal operation of the software, the method comprising steps of:
(1) providing both the software and the storage device with a recognition code corresponding to the kind of machine that will employ the storage device;
(2) executing the burning program;
(3) determining whether the recognition code of the software is consistent with that of the storage device; whereupon, if the codes are consistent, Step (4) is performed, and, if the codes are inconsistent, Step (5) is performed instead;
(4) burning the software into the storage device prior to performing Step (5); and
(5) terminating the burning program.

13. The method for preventing software from being wrongly burned of claim 12, wherein the software is basic input output system (BIOS) software.

14. The method for preventing software from being wrongly burned of claim 12 or claim 13, wherein the machine is a motherboard.

15. The method for preventing software from being wrongly burned of claim 12, wherein the recognition code is provided in the storage unit by a burning method.

16. The method for preventing software from being wrongly burned of claim 12, wherein determination of whether the recognition code of the software is consistent with that of the storage device is made by the burning program.

17. The method for preventing software from being wrongly burned of claim 12 or claim 16, wherein the burning program is provided on a burning platform having a display.

18. The method for preventing software from being wrongly burned of claim 17, wherein, when the recognition code of the basic input output system software is inconsistent with the recognition code of the storage device, an error signal is sent out to the burning platform by the burning program, such that an error indication may be displayed on the display of the burning platform.

19. The method for preventing software from being wrongly burned of claim 12, 15 or 16, wherein the storage device is selected from the group consisting of a flash ROM, PROM, EPROM and EEPROM.

20. A method for preventing software from being wrongly burned, such that basic input output system (BIOS) software can be correctly burned into a storage device of a motherboard of a machine corresponding to the software by a burning program, so as to provide normal operation of the basic input output system software, the method comprising steps of:
(1) providing both the basic input output system software and the storage device with a recognition code corresponding to the motherboard of the machine;
(2) executing the burning program;
(3) determining whether the recognition code of the basic input output system software is consistent with that of the storage device; whereupon, if the codes are consistent, Step (4) is performed, and, if the codes are inconsistent, Step (5) is performed instead;
(4) burning the basic input output system software into the storage device prior to performing Step (5); and
(5) terminating the burning program.

21. The method for preventing software from being wrongly burned of claim 20, wherein the recognition code is provided in the storage device by a burning method.

22. The method for preventing software from being wrongly burned of claim 20, wherein determination of whether the recognition code of the basic input output system software is consistent with that of the storage device is made by the burning program.

23. The method for preventing software from being wrongly burned of claim 20 or claim 22, wherein the burning program is provided on a burning platform having a display.

24. The method for preventing software from being wrongly burned of claim 23, wherein, when the recognition code of the basic input output system software is inconsistent with the recognition code of the memory, an error signal is sent out to the burning platform by the burning program, such that an error indication may be displayed on the display of the burning platform.

25. The method for preventing software from being wrongly burned of claim 20, 21 or 22, wherein the memory is selected from the group consisting of a flash ROM, PROM, EPROM and EEPROM.
